(19) United States
(12) Patent Application Publication
(10) Pub. No.: US 2017/0085784 A1
(43) Pub. Date: Mar. 23, 2017

(54) METHOD FOR IMAGE CAPTURING AND AN ELECTRONIC DEVICE USING THE METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YU ZHANG, Shenzhen (CN)

(21) Appl. No.: 14/926,938

(22) Filed: Oct. 29, 2015

(30) Foreign Application Priority Data
Sep. 17, 2015 (CN) 201510592393.4

(51) Int. Cl. H04N 5/232; G06K 9/78; G06K 9/00

(52) U.S. Cl. CPC H04N 5/23219; H04N 5/23293; G06K 9/00355; G06K 9/78

(57) ABSTRACT

In an image capturing method via a gesture operation, an image of the gesture operation is captured when a request to take an image via a gesture is made. The captured image of the gesture operation is recognized. An enclosed pattern or a semi-enclosed pattern is determined whether to be included in the captured image. If yes, the captured image is stored and a new image is captured. Then, the new image is compared with the image containing the enclosed pattern or the semi-enclosed pattern. The area of the new image to be displayed, and image object located at the area of the new image to be displayed are determined. A preview image is generated based on the image object located at the area to be displayed and displayed.

### CROSS-REFERENCE TO RELATED APPLICATIONS

This application claims priority to Chinese Patent Application No. 201510592393.4 filed on Sep. 17, 2015, the contents of which are incorporated by reference herein.

### FIELD

The subject matter herein generally relates to electronic devices, and more specifically relates to, a method for image capturing, and an electronic device using the method.

### BACKGROUND

Electronic devices, such as mobile phones, tablet computers, can be equipped with cameras. The cameras enable a user to capture images with easy as many of these devices are carried by users at any given time.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a hardware environment for executing an image capturing system.

FIG. 2 is a block diagram of one embodiment of function modules of the image capturing system in FIG. 1.

FIG. 3 is a flowchart of one embodiment of a method for capturing an image via a gesture.

FIG. 4 is a diagrammatic view of one embodiment of a gesture used for image capturing, in which an enclosed pattern is formed.

FIG. 5 is a diagrammatic view of one embodiment of another gesture used for image capturing, in which a semi-enclosed pattern is formed.

FIG. 6 is a diagrammatic view of an image which is captured without the gesture operation.

FIG. 7 is a diagrammatic view of an image which is captured via the gesture operation as shown in FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

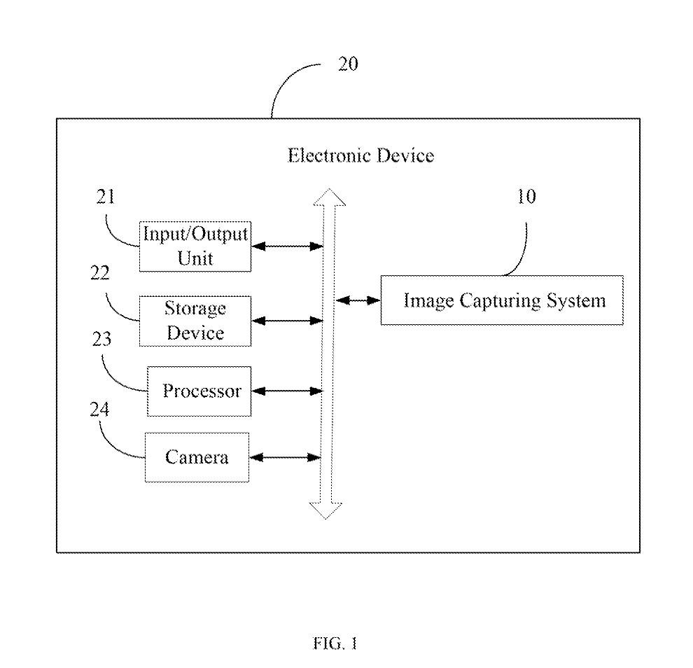

FIG. 1 is a block diagram of one embodiment of a hardware environment for executing an image capturing system. The image capturing system 10 is installed and runs in an apparatus, for example an electronic device 20. In at least one embodiment as shown in FIG. 1, the electronic device 20 includes, but is not limited to, an input/output device 21, a storage device 22, at least one processor 23, and at least one camera 24. The electronic device 20 can be a tablet computer, a notebook computer, a smart phone, a personal digital assistant (PDA), or other suitable electronic device. FIG. 1 illustrates only one example of the electronic device; other examples can include more or fewer components than illustrated, or have a different configuration of the various components in other embodiments.

The image capturing system 10 can capture an image of a gesture operation when a request to capture an image via a gesture is made. The image capturing system 10 recognizes the captured image of the gesture operation, and determines whether an enclosed pattern or a semi-enclosed pattern is included in the captured image. If the enclosed pattern or a semi-enclosed pattern is included in the captured image, the image capturing system 10 stores the captured image containing the enclosed pattern or the semi-enclosed pattern. The image capturing system 10 then captures a new image, and determines the area of the new image to be displayed and image object of the new image location at the area to be displayed. The image capturing system 10 further generates a preview image based on the image object located at the area to be displayed, and displays the generated preview image.

In at least one embodiment, the input/output unit 21 can be used by a user to input commands and display captured images to the user. In the illustrated embodiment, the input/output unit 21 is a touch screen. The storage device 22 can include various types of non-transitory computer-readable storage mediums. For example, the storage device 22 can be an internal storage system, such as a flash memory, a random access memory (RAM) for temporary storage of information, and/or a read-only memory (ROM) for permanent storage of information. The storage device 22 can also be an external storage system, such as a hard disk, a storage card, or a data storage medium. The at least one processor 23 can be a central processing unit (CPU), a microprocessor, or other data processor chip that performs functions of the image capturing system 10 in the electronic device 20. The at least one camera 24 is a digital camera. In at least one embodiment, the at least one camera 24 is selectively installed on a front side, or on a back side of the electronic device 20. In an alternative embodiment, the electronic device 20 includes two cameras 24, one of which is installed on the front side of the electronic device 20, and another of which is installed on the back side of the electronic device 20.

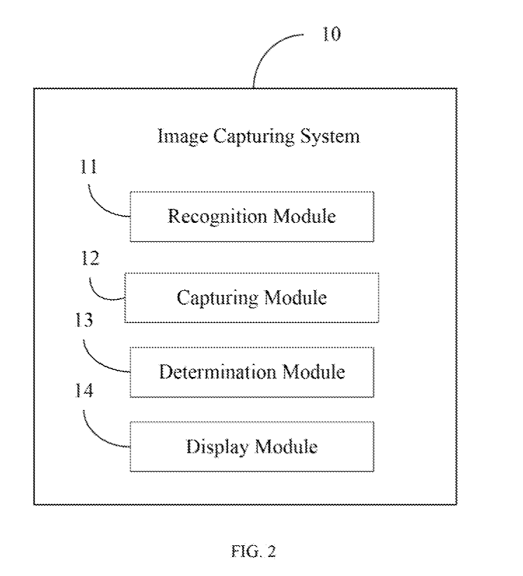

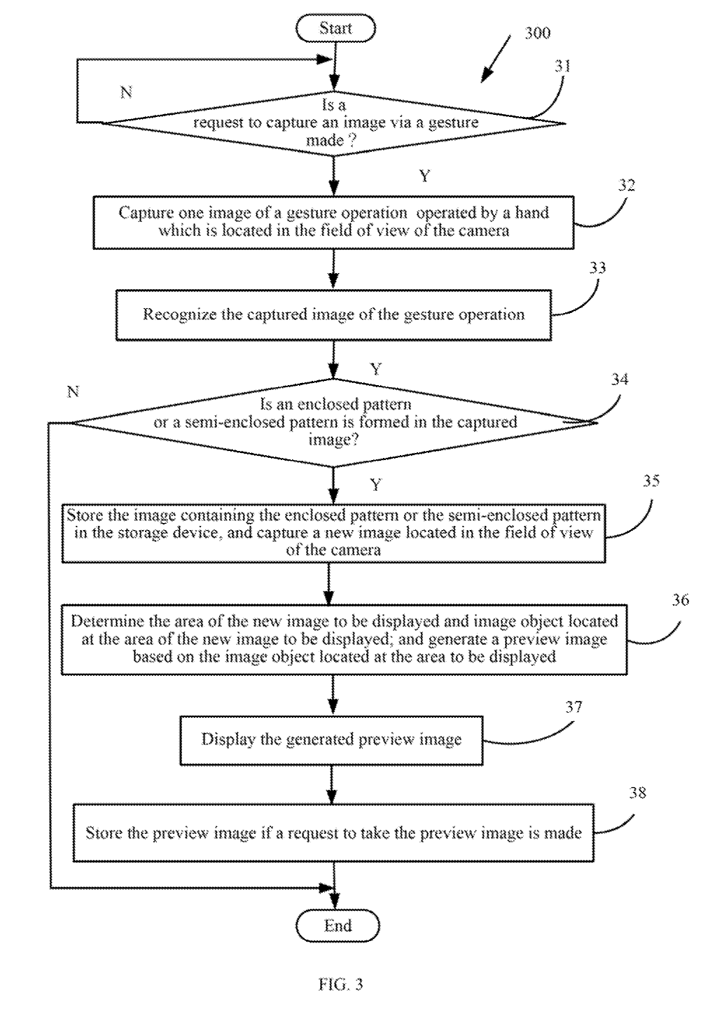

FIG. 2 is a block diagram of one embodiment of the function modules of the image capturing system 10. In at least one embodiment, the image capturing system 10 can include a recognition module 11, a capturing module 12, a determination module 13, and a display module 14. The function modules 11-14 can include computerized codes in the form of one or more programs, which are stored in the storage device 22. The at least one processor 23 executes the computerized codes to provide functions of the function modules 11-14. A detailed description of the functions of the modules 11-14 is given below in reference to FIG. 3.

FIG. 3 is a flowchart of one embodiment of a method for capturing an image via a gesture. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can change. The exemplary method 300 can begin at block 31. Depending on the embodiment, additional steps can be added, others removed, and the ordering of the steps can be changed.

At block 31, the recognition module determines whether a request to capture an image via a gesture is made. If yes, the process goes to block 32; if no, the process goes back to block 31.

In the illustrated embodiment, a user can operate a particular touch button, icon or menu which is displayed on the input/output device 21 to input the request to capture an image via a gesture. In other embodiments, a user can operate a particular button (not shown in FIGS) of the electronic device 20 to input the request.

At block 32, the capturing module captures, via the camera, one image of a gesture operation operated by a hand which is located in the field of view of the camera.

In other embodiments, more than one image of the gesture operation is captured.

It is known, in order to capture the image of a gesture operation, a hand is needed to hold the electronic device 20, that is, only one hand is needed to perform the gesture operation.

At block 33, the recognition module recognizes the captured image of the gesture operation.

In at least one embodiment, the recognition module 11 recognizes fingers contained in the image captured by the capturing module 12, and determines a position of each of the fingers, a position relationship between any two fingers, and patterns formed by the any two fingers.

At block 34, the determination module determines whether an enclosed pattern or a semi-enclosed pattern is formed in the captured image recognized by the recognition module. If yes, the process goes to block 35; if no, the process goes to end.

In the illustrated embodiment, the enclosed pattern further includes a pattern which approaches to be enclosed, for example, a pattern like the character C. In the illustrated embodiment, the enclosed pattern is formed when any two fingers are bent towards each other and a blank space is encircled by the two bent fingers. In at least one embodiment, the recognition module 11 obtains three points from a image of a finger, one of the three points lies in a highest position, and one of the three points lies in a lowest position. When the recognition module 11 recognizes the three points are not aligned the determination module 13 determines that the finger containing the three points is bent. When a pattern containing a circle, or an oval, or like a character C is formed by the two bent fingers, the determination module 13 determines an enclosed pattern is formed by the two bent fingers.

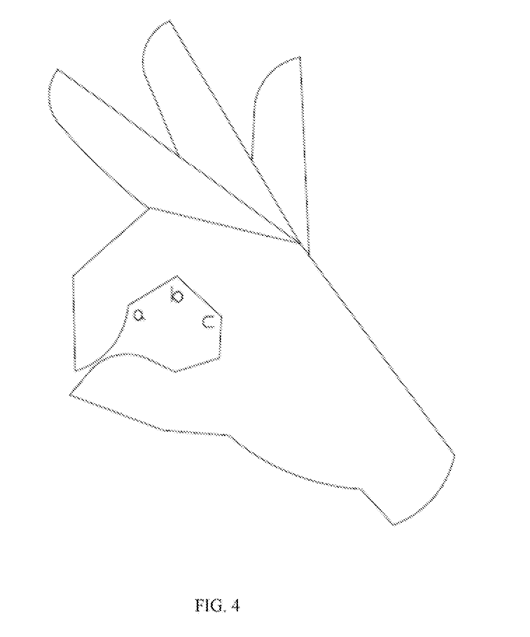

FIG. 4 illustrates a gesture in which the enclosed pattern is formed. In the illustrated embodiment, the gesture is an OK sign. In the gesture, the character O is formed by a thumb and an index finger. In the recognition of the gesture, the recognition module 11 obtains any three points, such as point a, point b, and point c, from the image of the thumb. The determination module 13 determines the three points are not aligned according to coordinates of the three points, and then determines the thumb is bent. The recognition module 11 recognizes the index finger in relation to the thumb, and determines a circle pattern is formed by the thumb and the index finger.

In the illustrated embodiment, the semi-enclosed pattern is formed when any two fingers are unbent and an angle formed between the two unbent fingers is less than 180°. In at least one embodiment, the recognition module 11 obtains three points from an image of the finger, one of the three points lies in a highest position, and one of the three points lies in a lowest position. When the recognition module 11 recognizes the three points are aligned, the determination module 13 determines the finger containing the three points is unbent.

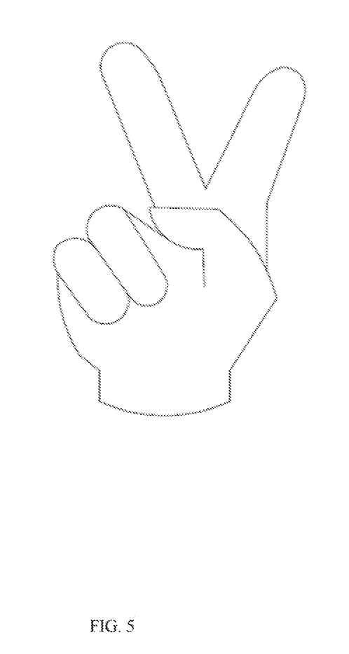

FIG. 5 illustrates a gesture in which a semi-enclosed pattern is formed. The gesture gives a V sign. In the gesture, the character V is formed by an index finger and a middle finger, and a semi-enclosed pattern is formed between the index finger and the middle finger. The character V can be formed by two adjacent fingers or by two nonadjacent fingers.

In the illustrated embodiment, an area defined by the enclosed pattern or the semi-enclosed pattern is equal to a display area of an image captured by the camera 24. For example, an area range defined by the character O or the character V containing in the image of the gesture operation is the display area of a captured image to be displayed.

In at least one embodiment, when an enclosed pattern and a semi-enclosed pattern are simultaneous contained in the captured gestured operation, the enclosed pattern is priority to the semi-enclosed pattern. That is, in this condition, the determination module 13 determines the area of the enclosed pattern is the area of the captured images to be displayed.

In at least one embodiment, when an enclosed pattern and a semi-enclosed pattern are simultaneously contained in the captured gesture operation, the determination module 13 compares the area of the enclosed pattern and the semi-enclosed pattern, and determines the pattern which has a bigger area is the area of the captured images to be displayed.

The image object is located in the area of the new image to be display and can be viewed.

At block 35, the determination module stores the image containing the enclosed pattern or the semi-enclosed pattern in the storage device, and captures a new image located in the field of view of the camera.

At block 36, the determination module determines the area of the new image to be displayed and image object located at the area of the new image to be displayed; and generates a preview image based on the image object located at the area to be displayed.

In at least one embodiment, the determination module determines the area of the new image to be displayed and image object located at the area of the new image to be displayed by comparing the new image with the image contained the enclosed pattern or the semi-enclosed pattern. In other embodiments, the determination module determines the area of the new image to be displayed and image object located at the area of the new image to be displayed according to coordinates of the enclosed pattern or the semi-enclosed pattern.

In the illustrated embodiment, the area of the new image to be displayed depends on the area range of the enclosed pattern or the semi-enclosed pattern contained by the captured image of the gesture operation. In at least one embodiment, the area of the new image to be displayed corresponds to the area range of the enclosed pattern or the semi-enclosed pattern contained by the captured image of the gesture operation.

At block 37, the display module displays the generated preview image.

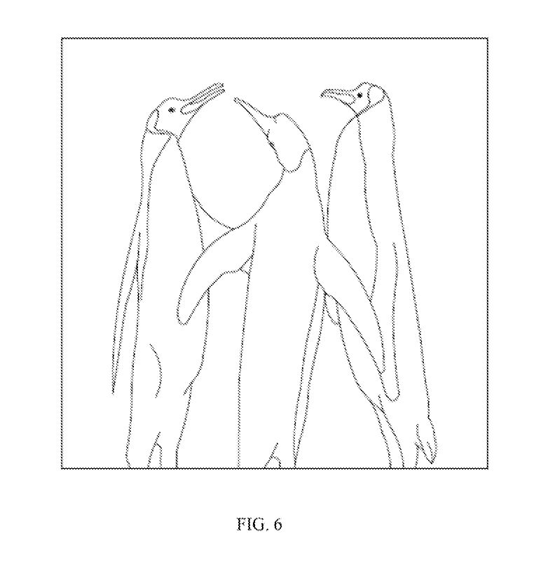

FIG. 6 illustrates a new image captured by the camera without using the gesture operation.

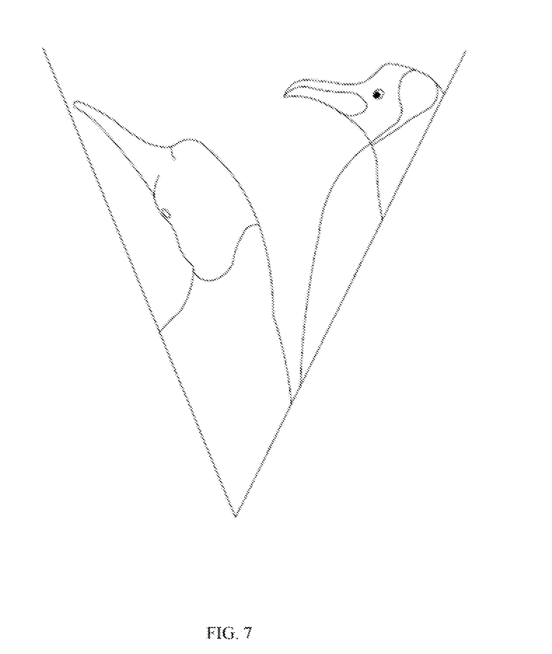

FIG. 7 illustrates a preview image associated with the new image of FIG. 6 via the gesture operation as shown in FIG. 5.

At block 38, the recognition module recognizes a request to capture the preview image is made; the capturing module stores the preview image in response the second request to capture the preview image.

In the illustrated embodiment, a user can operate a particular button (not shown in FIGS) of the electronic device 20 to input the request. In other embodiments, the electronic device 20 is equipped with a front-facing camera 24. When the front-facing camera 24 captures a predefined gesture operation or a predefined facial expression such as smile, the recognition module 11 recognizes the request to capture the preview image is made.

In other embodiments, the block 38 can be omitted.

The embodiments shown and described above are only examples. Many details are often found in the art and many such details are therefore neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An image capturing method via a gesture operation being executed by at least one processor of an electronic device, the electronic device comprising at least one camera and a display device, the method comprising:
capturing, at the electronic device, an image of the gesture operation via the at least one camera;
recognizing, at the electronic device, the captured image of the gesture operation;
determining, at the electronic device, whether an enclosed pattern or a semi-enclosed pattern is included in the captured image;
storing, at the electronic device, the image containing the enclosed pattern or the semi-enclosed pattern in a storage device if the enclosed pattern or the semi-enclosed pattern is included;
capturing, at the electronic device, a new image located in the field of view of the camera;
determining, at the electronic device, the area of the new image to be displayed and image object located at the area of the new image to be displayed;
generating, at the electronic device, a preview image based on the image object located at the area to be displayed; and
displaying, at the electronic device, the generated preview image.

2. The image capturing method according to claim 1, wherein the enclosed patterns is included by any two bent fingers which are bent towards each other.

3. The image capturing method according to claim 2, wherein the enclosed pattern is included if the pattern, which contains a substantial circle, or a substantial oval, or a substantial character C, is formed by the two bent fingers.

4. The image capturing method according to claim 3, further comprising:
obtaining, at the electronic device, three points from the image of the figure, wherein one of the three points lies in a highest position, and one of the three points lies in a lowest position; and
determining, at the electronic device, the finger is bent if the three points do not align.

5. The image capturing method according to claim 1, wherein the semi-enclosed pattern is included by any two unbent fingers if an angle formed between the two unbent fingers is smaller than 180 degrees.

6. The image capturing method according to claim 5, further comprising:
obtaining, at the electronic device, three points from the image of the figure, wherein one of the three points lies in a highest position, and one of the three points lies in a lowest position; and
determining, at the electronic device, the finger is unbent if the three points align.

7. The image capturing method according to claim 1, wherein the area of the new image to be displayed depends on the area range defined by the enclosed pattern or the semi-enclosed pattern.

8. An electronic device, comprising:
a processor; and
a storage device that stores one or more programs which, when executed by the at least one processor, cause the at least one processor to:
capturing, at the electronic device, an image of the gesture operation via a camera installed on the electronic device;
recognizing, at the electronic device, the captured image of the gesture operation;
determining, at the electronic device, whether an enclosed pattern or a semi-enclosed pattern is included in the captured image;
storing, at the electronic device, the image containing the enclosed pattern or the semi-enclosed pattern in a storage device if the enclosed pattern or the semi-enclosed pattern is included;
capturing, at the electronic device, a new image located in the field of view of the camera;
determining, at the electronic device, the area of the new image to be displayed and image object located at the area of the new image to be displayed;
generating, at the electronic device, a preview image based on the image object located at the area to be displayed; and
displaying, at the electronic device, the generated preview image.

9. The electronic device according to claim 8, wherein the enclosed patterns is included by any two bent fingers which are bent towards each other.

10. The electronic device according to claim 9, wherein the enclosed pattern is included if the pattern, which contains a substantial circle, or a substantial oval, or a substantial character C, is formed by the two bent fingers.

11. The electronic device according to claim 10, further comprising:
obtaining, at the electronic device, three points from the image of the figure, wherein one of the three points lies in a highest position, and one of the three points lies in a lowest position; and
determining, at the electronic device, the finger is bent if the three points do not align.

12. The electronic device according to claim 8, wherein the semi-enclosed patterns is included by any two unbent fingers if an angle formed between the two unbent fingers is smaller than 180 degrees.

13. The electronic device according to claim 12, further comprising:
obtaining, at the electronic device, three points from the image of the figure, wherein one of the three points lies in a highest position, and one of the three points lies in a lowest position; and
determining, at the electronic device, the finger is unbent if the three points align.

14. The electronic device according to claim 8, wherein the area of the new image to be displayed depends on the area range defined by the enclosed pattern or the semi-enclosed pattern.

15. A non-transitory storage medium having stored thereon instructions that, when executed by a processor of an electronic device, causes the processor to perform an image capturing method, wherein the image capturing method comprises:
capturing, at the electronic device, an image of the gesture operation via a camera installed on the electronic device;
recognizing, at the electronic device, the captured image of the gesture operation;
determining, at the electronic device, whether an enclosed pattern or a semi-enclosed pattern is included in the captured image;
storing, at the electronic device, the image containing the enclosed pattern or the semi-enclosed pattern in a storage device if the enclosed pattern or the semi-enclosed pattern is included;
capturing, at the electronic device, a new image located in the field of view of the camera;
determining, at the electronic device, the area of the new image to be displayed and image object located at the area of the new image to be displayed;
generating, at the electronic device, a preview image based on the image object located at the area to be displayed; and
displaying, at the electronic device, the generated preview image.

16. The non-transitory storage medium according to claim 15, wherein the enclosed pattern is included by any two bent fingers which are bent towards each other.

17. The non-transitory storage medium according to claim 16, wherein the enclosed pattern is included if the pattern, which contains a substantial circle, or a substantial oval, or a substantial character C, is formed by the two bent fingers.

18. The non-transitory storage medium according to claim 17, further comprising:
obtaining, at the electronic device, three points from the image of the figure, wherein one of the three points lies in a highest position, and one of the three points lies in a lowest position; and determining, at the electronic device, the finger is bent if the three points do not align.

19. The non-transitory storage medium according to claim 15, wherein the semi-enclosed patterns is included by any two unbent fingers if an angle formed between the two unbent fingers is smaller than 180 degrees.

20. The non-transitory storage medium according to claim 19, further comprising
obtaining, at the electronic device, three points from the image of the figure, wherein one of the three points lies in a highest position, and one of the three points lies in a lowest position; and
determining, at the electronic device, the finger is unbent if the three points align.
